(19) United States
(12) Patent Application Publication
(10) Pub. No.: US 2018/0194038 A1
(43) Pub. Date: Jul. 12, 2018

(54) MOLDING DIE AND PLATE-SHAPED OPTICAL COMPONENT FABRICATED USING SAME, AND METHOD FOR MANUFACTURING SAME

(71) Applicant: Konica Minolta, Inc., Tokyo (JP)

(72) Inventor: Tomonobu Tokunaga, Sakai-shi, Osaka (JP)

(73) Assignee: Konica Minolta, Inc., Tokyo (JP)

(21) Appl. No.: 15/746,381

(22) PCT Filed: Jun. 15, 2016
(86) PCT No.: PCT/JP2016/067772

§ 371 Date: Jan. 19, 2018

(30) Foreign Application Priority Data
Jul. 21, 2015 (JP) 2015-143920

(51) Int. Cl. B29C 33/42; G02B 27/01; B29C 33/38; B29C 45/26; B60K 35/00

(52) U.S. Cl. CPC B29C 33/42; G02B 27/01; B60K 35/00; B29C 45/26; B29C 33/3842

(57) ABSTRACT

An aspect of a mold is for forming therein a cavity for producing a plate-like optical component. The mold includes a stationary mold half, and a movable mold half which forms the cavity in cooperation with the stationary mold half. The stationary mold half includes a first surface mold member for forming a first surface which is one of obverse and reverse surfaces of the plate-like optical component, and a first peripheral mold member for connecting a cavity-side surface of the movable mold half and a cavity-side surface of the first surface mold member. The first peripheral mold member inclines or curves to cause a dimension of the cavity in a direction of a plane approximately parallel to the first surface to become gradually smaller as being closer to the first surface.

### TECHNOLOGICAL FIELD

The present invention relates to a mold capable of simply producing a plate-like optical component having an end face with a smooth shape, a plate-like optical component produced using the mold, and a production method for the plate-like optical component.

### BACKGROUND

In recent years, great interest has been shown in a head up display (hereinafter also denoted “HUD”) system, as a new system for vehicles such as automobiles, having the potential to replace car navigation systems. The HUD system is capable of enabling a driver to acquire information necessary for driving, while looking forwardly, so that it has an advantage of being able to enhance safety during vehicle traveling, as compared to conventional car navigation systems.

Heretofore, the HUD has been mounted only on the latest model of passenger airplane such as Boeing 787 and a small percentage of luxury vehicles. However, in recent years, the operation of an automobile insurance plan designed to give preferential treatment to an automobile with the HUD has been studied, particularly, in Europe nations and the United States. Thus, the HUD is expected to become even more popular in the future.

A display method using the HUD includes two types: one type using a front windshield as a display; and the other type using as a display a semi-transparent, plate-like, resin optical component, so-called “combiner”. In the former display method, information is directly displayed on a front windshield, so that there is a merit that it is not required to newly provide an additional component, but, on the other hand, there is a need to carry out optical design depending on a type of automobile while taking into account a shape of a front windshield, so that cost is liable to increase. In the latter display method, the HUD system can be introduced simply by attaching a combiner.

Such a combiner can be produced by an injection molding method described, for example, in the following Patent Literatures 1 and 2. In the injection molding method disclosed in the Patent Literature 1, first of all, a first mold half and a second mold half are matched and clamped together through respective parting surfaces thereof. Then, molten resin is filled in a cavity formed between the first mold half and the second mold half. This molten resin is cured, and the first mold half and the second mold half are detached from the cured resin to obtain a resin molded product.

When the resin molded product produced by the production method disclosed in the Patent Literature 1 is used as an optical component such as an HUD combiner, reflection of light due to an outer periphery face of the resin molded product causes poor visibility of a display region of the combiner. Moreover, there is concern that a driver gets injured by a burr or an edge existing on an outer periphery of the resin molded product. In order to prevent such problems, it is necessary to correct an end face of the resin molded product so as to have a smooth shape, for example, by polishing the end face of the resin molded product. Thus, it is required to omit processing such as the above polishing to more simply produce an optical component.

### CITATION LIST

### Patent Document

Patent Literature 1: JP 2010-241133 A

Patent Literature 2: JP 2010-274440 A

### SUMMARY

It is an object of the present invention to provide a plate-like optical component having an end face with a smooth shape, and a production method for the plate-like optical component, and to provide a mold capable of simply producing the plate-like optical component.

According to an aspect of the present invention, there is provided a mold for forming therein a cavity for producing a plate-like optical component. The mold includes: a stationary mold half; and a movable mold half which is clamped with respect to the stationary mold half through respective parting surfaces thereof to thereby form the cavity in cooperation with the stationary mold half, wherein the stationary mold half includes: a first surface mold member for forming a first surface which is one of obverse and reverse surfaces of the plate-like optical component; and a first peripheral mold member for connecting a surface of the movable mold half on a side of the cavity and a surface of the first surface mold member on a side of the cavity, wherein the first peripheral mold member inclines or curves to cause a dimension of the cavity in a direction of a plane approximately parallel to the first surface to become gradually smaller as being closer to the first surface.

According to an aspect of the present invention, there is provided a plate-like optical component produced by filling molten resin in a cavity formed by clamping a stationary mold half and a movable mold half together, and curing the molten resin. The plate-like optical component includes: a first surface which is one of obverse and reverse surfaces of the plate-like optical component; a second surface which lies in spaced-apart relation to the first surface: a lateral face which connects the first surface and the second surface together; and a parting line which is formed on the lateral face by respective contact surfaces of the stationary mold half and the movable mold half, wherein a part of the lateral face which connects between the parting line and an outer periphery of the first surface is a first peripheral portion inclining or curving to cause a dimension of the plate-like optical component in a direction of a plane approximately parallel to the first surface to become gradually smaller as being closer to the first surface.

According to an aspect of the present invention, there is provided a plate-like optical component production method which comprises the steps of: clamping a stationary mold half and a movable mold half together to form a cavity between the stationary mold half and the movable mold half; filling molten resin in the cavity and curing the molten resin to form a plate-like optical component; separating the movable mold half from the stationary mold half together with the plate-like optical component; and detaching the plate-like optical component from the movable mold half, wherein the movable mold half includes: a second surface mold member for forming a second surface of the plate-like optical component; and a second peripheral mold member for connecting a surface of the stationary mold half on a side of the cavity and a surface of the second surface mold member on a side of the cavity, wherein the second peripheral mold member inclines or curves to cause a dimension of the cavity in a direction of a plane approximately parallel to the first surface to become gradually smaller as being closer to the second surface, and wherein the step of detaching the plate-like optical component includes a step of causing the second surface mold member of the movable mold half to relatively protrude with respect to the second peripheral mold member of the movable mold half.

Therefore, the plate-like optical component production method and the mold of the present invention make it possible to provide a plate-like optical component having an end portion with a smooth shape.

These and other objects, features, and advantages of the present invention will become apparent upon reading of the following detailed description along with the accompanying drawings.

### BRIEF DESCRIPTION OF THE DRAWINGS

FIG. 1 is a front view of a plate-like optical article according to an embodiment 1 of the present invention, as viewed from the side of a first surface thereof.

FIG. 2 is a back view of the plate-like optical article according to the embodiment 1, as viewed from the side of a second surface thereof.

FIG. 3 is a top view of the plate-like optical article according to the embodiment 1, as viewed from thereabove.

FIG. 4 is a left side view of the plate-like optical article according to the embodiment 1, as viewed from the side of a left lateral face thereof.

FIG. 5 is a sectional view of a mold for producing the plate-like optical component according to the embodiment 1, taken along a plane perpendicular to an upward-downward direction.

FIG. 6 is a sectional view of the mold for producing the plate-like optical component according to the embodiment 1, taken along a plane perpendicular to a rightward-leftward direction.

FIG. 7 is a plan view of a movable mold half as viewed from the side of a parting surface thereof.

FIG. 8 is a plan view of a stationary mold half as viewed from the side of a parting surface thereof.

FIG. 9 is a schematic sectional view depicting a state after clamping the stationary mold half and the movable mold half together.

FIG. 10 is a schematic sectional view depicting a state after producing the plate-like optical component in a cavity.

FIG. 11 is a schematic sectional view depicting a state after separating the plate-like optical component from the stationary mold half by moving the movable mold half.

FIG. 12 is a schematic sectional view depicting a state after separating the plate-like optical component from a second peripheral mold member.

FIG. 13 is a sectional view of a mold in a modified embodiment 1, taken along the plane perpendicular to the upward-downward direction.

FIG. 14 is a top view of a plate-like optical article according to a modified embodiment 1, as viewed from thereabove.

### DETAILED DESCRIPTION OF EMBODIMENTS

Based on the drawings, an embodiment of the present invention will now be described. It should be noted that elements or components assigned with the same reference sign in the figures mean that they are identical, and therefore duplicated description thereof will be omitted. Further, each figure is schematically shown only for illustrative purposes, and the size and dimensional ratio of a plate-like optical component in each figure can be different from an actual size and dimensional ratio thereof.

### Embodiment 1

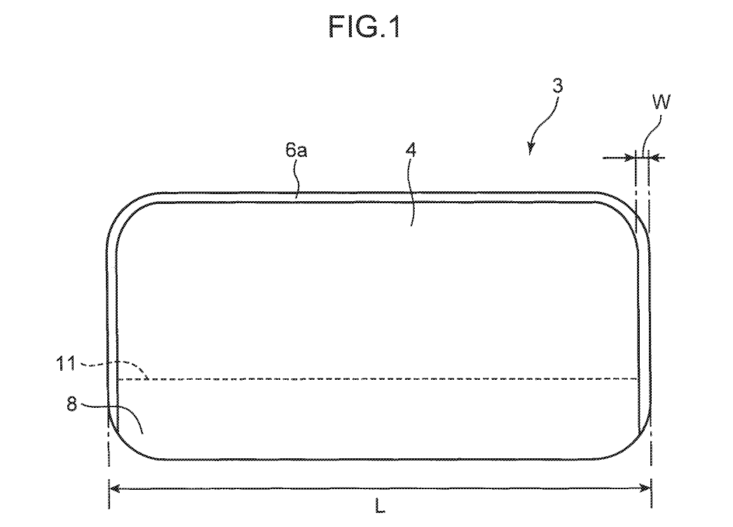

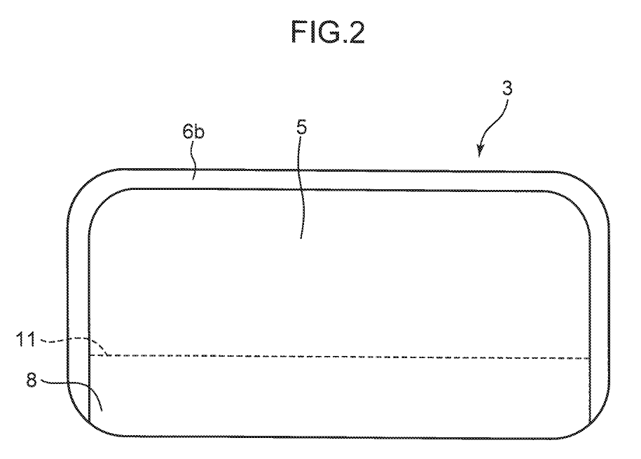

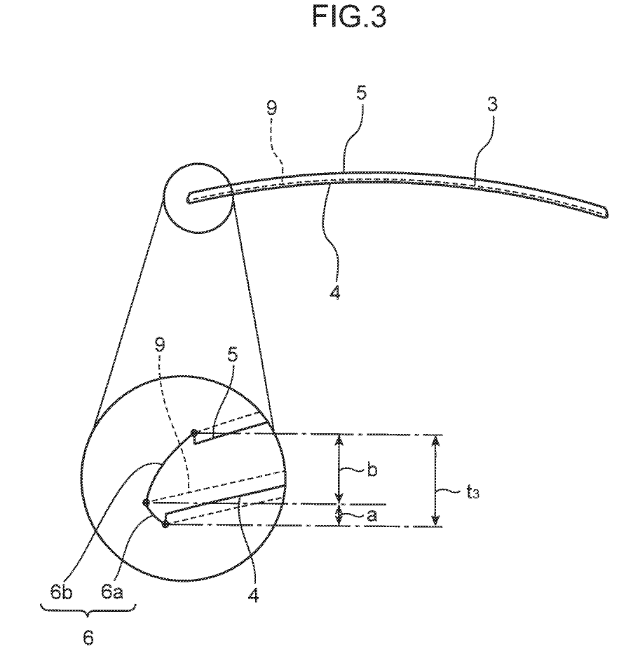

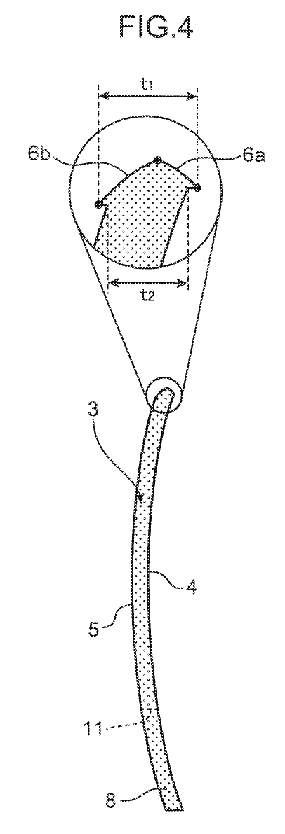

FIG. 1 is a front view of a plate-like optical component according to an embodiment 1 of the present invention, as viewed from the side of a first surface thereof. FIG. 2 is a back view of the plate-like optical component, as viewed from the side of a second surface thereof. FIG. 3 is a top view of the plate-like optical component, as viewed from thereabove. FIG. 4 is a left side view of the plate-like optical component, as viewed from the side of a left lateral face thereof. As depicted in FIGS. 1 to 4, the plate-like optical component 3 according to this embodiment is a plate-like component having a given thickness, and is suitably usable in an HUD combiner to be mounted on various moving bodies such as an airplane, a helicopter, a passenger vehicle and a commercial vehicle. In the case where the plate-like optical component according to this embodiment is used in an HUD combiner for an automobile, a variety of pieces of information helpful for driving of the automobile are displayed on the plate-like optical component 3, in the same manner as that in a commonly-used vehicle meter unit. Examples of the information include vehicle speed, current clock time, remaining fuel amount, road information, engine speed, headlight on/off state, vehicle malfunction, state of charge, safety information, and visibility-assisting information.

As regards an installation position of an HUD combiner within an automotive vehicle, the plate-like optical component 3 is mounted on an instrument panel (not depicted) on the side of a driver seat of the vehicle, in such a manner that an image display portion thereof is exposed outside of the instrument panel. By setting the mounting position in this manner, a driver can visually check information displayed on the combiner while driving.

(Plate-Like Optical Component)

As depicted in FIGS. 1 and 2, the plate-like optical component 3 according to this embodiment has an approximately rectangular shape whose four vertexes are chamfered, in the front view and the back view. The shape of the plate-like optical component 3 according to this embodiment is not limited to the approximately rectangular shape depicted in FIGS. 1 and 2, but may be set by a vehicle manufacturer, typically based on intended use, aesthetic design or the like of an automotive vehicle. “Front side” and “back side” in each viewing direction of FIGS. 1 and 2 correspond to a front-back direction of the plate-like optical component itself. A surface of the plate-like optical component opposed to a driver who is sitting on a right driver seat is defined as “front surface”, and the back side of the plate-like optical component as viewed from the side of the driver is defined as “back surface”. In the following description, “left” and “right” correspond, respectively, to left and right when viewing a surface of the plate-like optical component disposed in front of a right driver seat of a vehicle, from the side of the right driver seat (i.e., in the front view of FIG. 1). “Upper side” and “lower side” in the front view of FIG. 1 correspond to an upward-downward direction of the vehicle.

The plate-like optical component 3 according to this embodiment is produced by filling molten resin in a cavity formed by clamping a stationary mold half and a movable mold half together, and curing the molten resin. As depicted in FIG. 3, this plate-like optical component 3 has a first surface 4, a second surface 5 lying in spaced-apart and opposed relation to the first surface 4, and four lateral faces 6 connecting the first surface 4 and the second surface 5 together. In a state in which the stationary mold half and the movable mold half are clamped together, respective contact surfaces (parting surfaces) of the mold halves are in contact with an entire periphery of the plate-like optical component 3. Due to the parting surfaces, a parting line 9 is formed on each of the lateral faces of the plate-like optical component 3 along a longitudinal direction thereof, as depicted in FIG. 3. The parting line 9 is located on the side of the first surface 4 with respect to an intermediate position between the first surface 4 and the second surface 5. By forming the parting line 9 at the above position, it becomes possible to facilitate release of a molded plate-like optical component from a mold to thereby obtain a plate-like optical component with good external appearance.

As depicted in FIG. 3, a part of the lateral face 6 connecting between the parting line 9 and an outer periphery of the first surface 4 is a first peripheral portion 6a, and a part of the lateral face 6 connecting between the parting line 9 and an outer periphery of the second surface 5 is a second peripheral portion 6b. The first peripheral portion 6a inclines or curves to cause a dimension of the plate-like optical component 3 in a direction of a plane approximately parallel to the first surface 4 to become gradually smaller as being closer to the first surface 4. Similarly, the second peripheral portion 6b inclines or curves to cause a dimension of the plate-like optical component 3 in a direction of a plane approximately parallel to the second surface 5 to become gradually smaller as being closer to the second surface 5. As above, the end face (first peripheral portion 6a and second peripheral portion 6b) of the plate-like optical component has a smooth shape, so that it becomes possible to suppress light reflection at the end face and suppress injury of a driver due to the end face of the plate-like optical component 3.

In FIG. 3, a curvature radius of the first peripheral portion 6a is preferably less than a curvature radius of the second peripheral portion 6b, and an upward-downward directional length a from an inflection point between the first surface 4 and the first peripheral portion 6a to an inflection point between the first peripheral portion 6a and the second peripheral portion 6b is preferably less than an upward-downward directional length b from the inflection point between the first peripheral portion 6a and the second peripheral portion 6b to an inflection point between the second peripheral portion 6b and the second surface 5. This shape has an advantage of being able to facilitate release of the plate-like optical component 3 from an aftermentioned stationary mold half. Assuming that an upward-downward directional length from the inflection point between the first surface 4 and the first peripheral portion 6a to the inflection point between the second peripheral portion 6b and the second surface 5 is a thickness t3 of the plate-like optical component 3, the thickness of the plate-like optical component 3 is preferably from 1 mm to 20 mm.

The plate-like optical component 3 according to this embodiment has an attaching portion 8 at a lower portion located below the first and second surfaces 4, 5, as depicted in FIGS. 1 and 2. The first surface 4 and the attaching portion 8 are sectioned up and down by a parting line 11. The second surface 5 and the attaching portion 8 are sectioned up and down by a parting line 11. In the case where the plate-like optical component 3 is used in an HUD combiner, the attaching portion 8 of the plate-like optical component 3 is mounted on an instrument panel on the side of a driver seat, in such a manner that the first surface 4 is opposed to the driver seat. This makes it possible to mount the plate-like optical component 3 so as to fulfill a desired optical function. As long as the attaching portion 8 is provided as part of the plate-like optical component 3, the shape thereof is not particularly limited. For example, it may be provided in an entire region of the lower portion of the plate-like optical component 3 as depicted in FIGS. 1 and 2, or may be provided in part of the lower portion of the plate-like optical component 3.

The parting line 11 on the first surface is formed by respective contact surfaces (parting surfaces 1e) of a first surface mold member 1b and a first peripheral mold member 1a composing a stationary mold half 1. The parting line 11 on the second surface is formed by respective contact surfaces (parting surfaces 2e) of a second surface mold member 2b and a second peripheral mold member 2a composing a movable mold half 2. The first peripheral mold member 1a, the first surface mold member 1b, the second peripheral mold member 2a and the second surface mold member 2b will be described in detail later.

As depicted in FIG. 4, in the left side view of the plate-like optical component 3, the first peripheral portion 6a preferably protrudes with respect to the first surface 4, in a thickness direction of the plate-like optical component 3 (toward the surface side). Further, as depicted in FIG. 1, in the plan view as viewed from the side of the first surface, a width dimension W of the first peripheral portion 6a is preferably 0.2 mm or more, more preferably 0.3 mm or more, even more preferably 0.5 mm or more. This makes it possible to increase the rigidity of the end portion (first peripheral portion 6a).

As depicted in FIG. 1, in the plan view as viewed from the side of the first surface, a ratio of the width dimension W of the first peripheral portion 6a to a maximum length dimension L of the plate-like optical component 3 in a rightward-leftward direction thereof is preferably 0.04 or less, more preferably 0.03 or less, even more preferably 0.02 or less, particularly preferably 0.01 or less. The width of the first peripheral portion 6a to a maximum length dimension L of the plate-like optical component 3 is set to be small with respect to the rightward-leftward directional maximum length L of the plate-like optical component 3, so that it becomes possible to make it less likely for the first peripheral portion 6a to be recognized from outside, and thus obtain a plate-like optical component 3 with excellent external appearance. While it is difficult to uniformly set the rightward-leftward directional maximum length L of the plate-like optical component 3 because a desired value thereof varies depending on the intended use, the maximum length L is preferably set in the range, for example, of 10 mm to 1000 mm.

As depicted in FIG. 4, the first surface 4 is a concave surface concaved toward the back side, and the second surface 5 is a convex surface convexed toward the back side. Further, as depicted in FIG. 4, in the side view, the first surface 4 and the second surface 5 are approximately parallel to each other. However, the plate-like optical component 3 is not limited to the shape depicted in FIG. 4. For example, in the side view, one of the first surface 4 and the second surface 5 may be a planar shape, or the first surface 4 and the second surface 5 may be curved, respectively, with different curvature radii. The curvature radius, i.e., a degree of curvature toward the back side, of each of the first surface 4 and the second surface 5 can be set so as to obtain a desired optical function.

As depicted in FIG. 4, in the left side view, a width dimension t1 between a first surface-side edge of the first peripheral portion 6a and a second surface-side edge of the second peripheral portion 6b is slightly greater than a width dimension t2 between the first surface 4 and the second surface 5. Further, as depicted in FIG. 4, in the left side view, a step is formed in a connection area between the first peripheral portion 6a and the first surface 4 so as to enable the first peripheral portion 6a to become thicker than the first surface 4. A step is formed in a connection area between the second peripheral portion 6b and the second surface 5 so as to enable the second peripheral portion 6b to become thicker than the second surface 5. This shape has an advantage of being able to correct, by a mold, warpage of a molded plate-like optical component which is likely to occur during injection molding, while suppressing a thickness error in a peripheral end of the plate-like optical component, and thus make it more likely for the plate-like optical component 3 to fulfill a desired optical function.

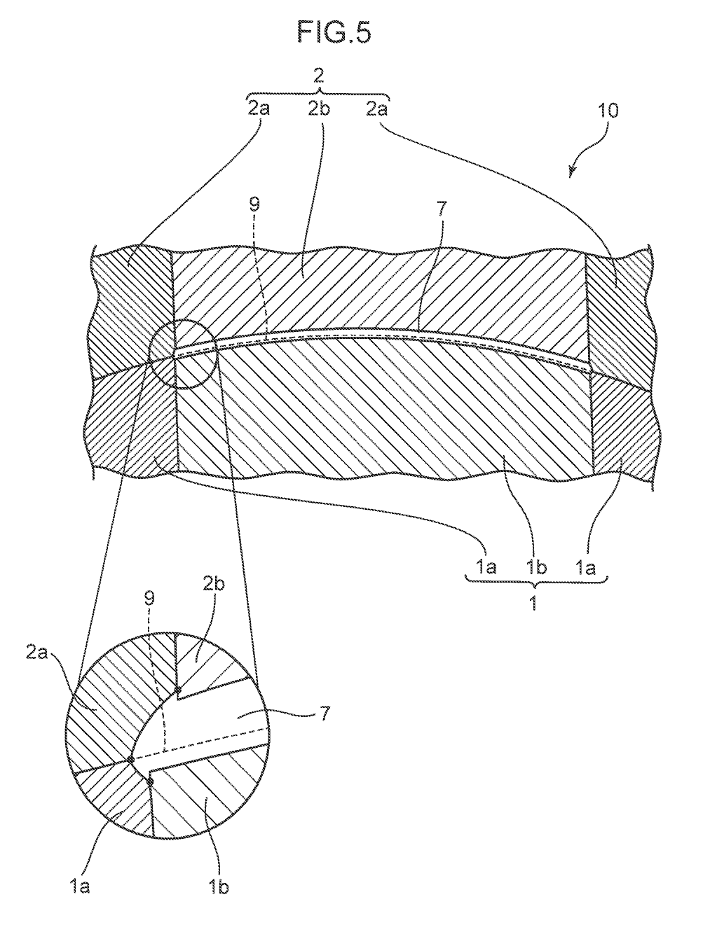

The connection area between the first peripheral portion 6a and the first surface 4 is not limited to the configuration having a step as depicted in FIGS. 4 and 5, but the first peripheral portion 6a and the first surface 4 may be smoothly connected together. As with the connection area between the first peripheral portion 6a and the first surface 4, the connection area between the second peripheral portion 6b and the second surface 5 is not limited to the configuration having a step as depicted in FIGS. 4 and 5, but the second peripheral portion 6b and the second surface 5 may be smoothly connected together.

(Mold)

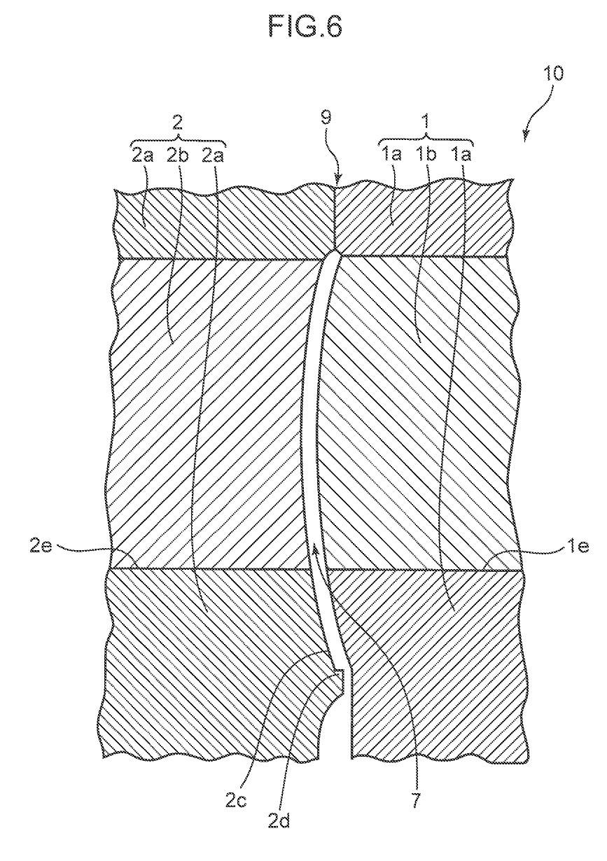

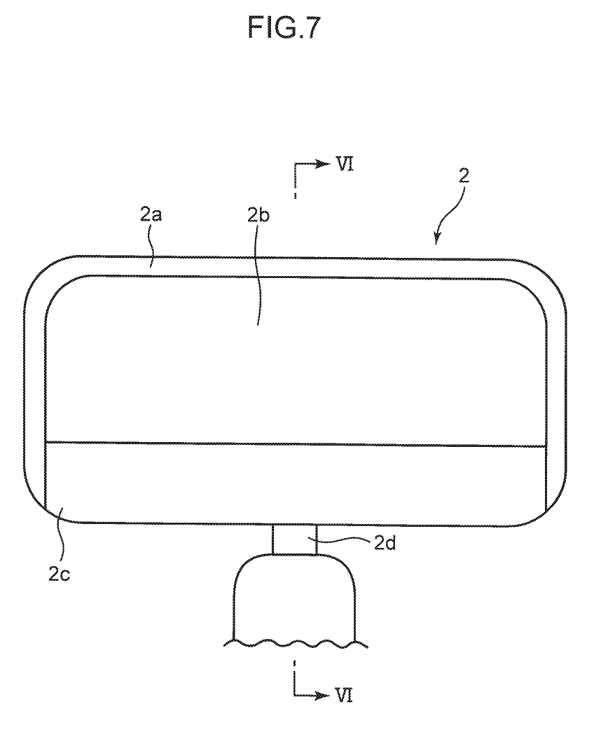

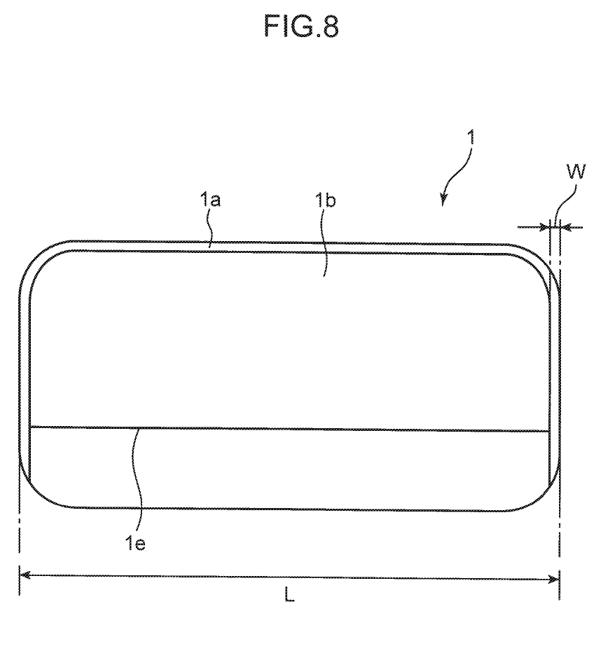

As a mold for producing the above plate-like optical component, it is preferable to use a mold depicted in FIGS. 5 to 8. FIG. 5 is a sectional view of a mold for producing the plate-like optical component according to the embodiment 1, taken along a plane perpendicular to an upward-downward direction thereof, and FIG. 6 is a sectional view of the mold for producing the plate-like optical component according to the embodiment 1, taken along a plane perpendicular to a rightward-leftward direction thereof. FIG. 7 and FIG. 8 are, respectively, plan views of a movable mold half and a stationary mold half, as viewed from the side of a cavity.

As depicted in FIG. 5, a mold 10 in this embodiment comprises a movable mold half 2 and a stationary mold half 1. The movable mold half 2 is configured to be matched with the stationary mold half 1 through respective parting surfaces of the stationary and movable mold halves 1, 2 to thereby form a cavity 7 thereinside. The plate-like optical component can be produced by filling molten resin in this cavity 7 and curing the molten resin.

As depicted in FIG. 6, the stationary mold half 1 includes the first surface mold member 1b and the first peripheral mold member 1a. The parting line 11 between the first surface 4 and the attaching portion 8 is formed by respective contact surfaces (parting surfaces 1e) of the first peripheral mold member 1a and the first surface mold member 1b. The parting line 11 between the second surface 5 and the attaching portion 8 is formed by respective contact surfaces (parting surfaces 2e) of the second peripheral mold member 2a and the second surface mold member 2b. The first surface mold member 1b is configured to form the first surface of the plate-like optical component, and the first peripheral mold member 1a is configured to form the first peripheral portion of the plate-like optical component. Although not depicted in the figures, the first peripheral mold member 1a is a mold having a hollow space therein. The first surface mold member 1b is inserted into the hollow space of the first peripheral mold member 1a. That is, the first peripheral mold member 1a is provided to surround a surface of the first surface mold member 1b other than a surface thereof on the side of the cavity. The first peripheral mold member 1a is configured to connect a surface of the movable mold half 2 on the side of the cavity 7 and a surface of the first surface mold member 1b on the side of the cavity 7. The first peripheral mold member 1a inclines or curves to cause a dimension of the cavity 7 in a direction of a plane approximately parallel to the first surface to become gradually smaller as being closer to the first surface. The use of the stationary mold half 1 having such a shape makes it possible to facilitate release of a molded plate-like optical component from the stationary mold half 1, and obtain a plate-like optical component with good quality of external appearance.

As depicted in FIG. 5, the surface of the first surface mold member 1b on the side of the cavity 7 protrudes toward the cavity 7 with respect to a surface of the first peripheral mold member 1a on the side of the cavity 7. By producing the plate-like optical component 3 using the stationary mold half 1 having such a shape, it becomes possible to produce the plate-like optical component 3 in which the first peripheral portion 6a protrudes with respect to the first surface 4, as depicted in FIGS. 4 and 5. By providing the first peripheral portion 6a having such a shape, it becomes possible to increase the rigidity of the end portion (first peripheral portion 6a) of the plate-like optical component 3, thereby providing an advantage that chip or deformation is less likely to occur in the plate-like optical component 3. Further, it becomes possible to correct, by the mold, warpage of a molded plate-like optical component which is likely to occur during injection molding, while suppressing a thickness error in the peripheral portion of the plate-like optical component. This makes it more likely for the plate-like optical component 3 to fulfill a desired optical function.

As depicted in FIG. 6, the movable mold half 2 includes the second surface mold member 2b and the second peripheral mold member 2a. The second surface mold member 2b is configured to form the second surface of the plate-like optical component. The second peripheral mold member 2a is configured to form the second peripheral portion of the plate-like optical component. Although not depicted in the figures, the second peripheral mold member 2a is a mold having a hollow space therein, and the second surface mold member 2b is inserted into this hollow space in such a manner as to be movable toward the cavity. That is, the second peripheral mold member 2a is provided to surround a surface of the second surface mold member 2b other than a surface thereof on the side of the cavity.

The second peripheral mold member 2a is configured to connect a surface of the stationary mold half 1 on the side of the cavity 7 and a surface of the second surface mold member 2b on the side of the cavity 7. The second peripheral mold member 2a inclines or curves to cause a dimension of the cavity 7 in a direction of a plane approximately parallel to the second surface to become gradually smaller as being closer to the second surface. The use of the movable mold half 2 having such a shape enables the end portion of the plate-like optical component to have a smooth surface when the plate-like optical component is extracted from the mold 10. This makes it possible to obtain a plate-like optical component having a suitable shape for use in a combiner, without subjecting the plate-like optical component to processing.

As depicted in FIG. 5, the surface of the second surface mold member 2b on the side of the cavity protrudes toward the cavity with respect to a surface of the second peripheral mold member 2a on the side of the cavity. By producing the plate-like optical component 3 using the movable mold half 2 having such a shape, it becomes possible to produce the plate-like optical component 3 in which the second peripheral portion 6b protrudes with respect to the second surface 5, as depicted in FIGS. 4 and 5. By providing the second peripheral portion 6b having such a shape, it becomes possible to increase the rigidity of the end portion (second peripheral portion 6b) of the plate-like optical component 3, thereby providing an advantage that chip or deformation is less likely to occur in the plate-like optical component 3. Further, it becomes possible to correct, by the mold, warpage of a molded plate-like optical component which is likely to occur during injection molding, while suppressing a thickness error in the peripheral portion of the plate-like optical component 3. This provides an advantage of making it more likely for the plate-like optical article 3 to fulfill a desired optical function.

The second surface mold member 2b is movably fixed with respect to the second peripheral mold member 2a. Based on this fixing configuration, the plate-like optical component can be extracted from the movable mold half 2.

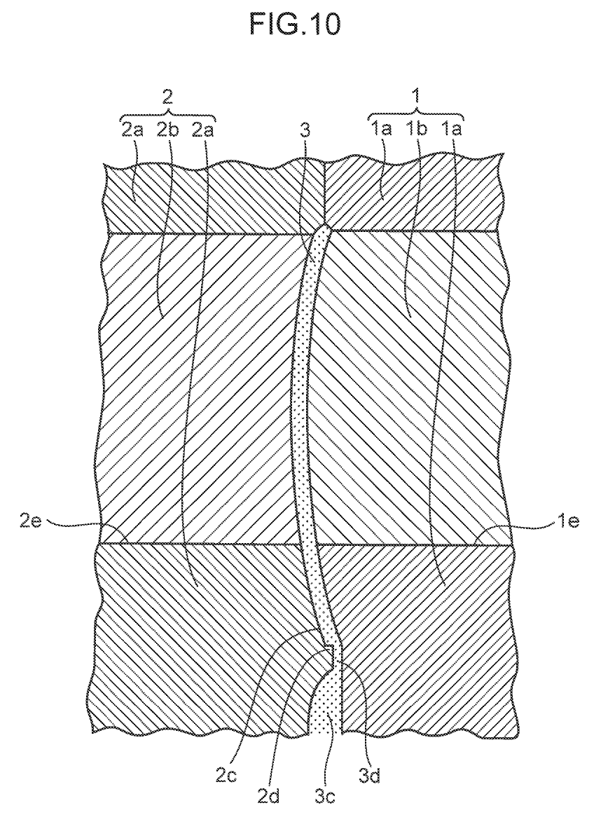

As depicted in FIGS. 6 and 7, an attaching portion-shaping section 2c and a gate section 2d are provided in a lower portion of the second peripheral mold member 2a. This attaching portion-shaping section 2c is configured to form the attaching portion 8 of the plate-like optical component 3. The gate section 2d protrudes toward the cavity with respect to a surface of the attaching portion-shaping section 2c on the side of the cavity. The gate section 2d is configured to form a gate-cut portion 3d connected to a lower end of the plate-like optical component 3. The plate-like optical component 3 can be obtained by cutting and separating a runner portion 3c at the gate-cut portion 3d, as depicted in FIG. 10.

As depicted in FIG. 5, the parting surfaces (corresponding to the parting line 9) are located on the side of the first surface mold member 1b with respect to an intermediate position between the surface of the first surface mold member 1b on the side of the cavity 7 and the surface of the second surface mold member 2b on the side of the cavity 7. By clamping the movable mold half 2 and the stationary mold half 1 at such a position, it becomes possible to facilitate release of the plate-like optical component from the stationary mold half 1 and thus facilitate production of the plate-like optical component with good external appearance.

The surface of the first surface mold member 1b on the side of the cavity 7 protrudes toward the cavity 7 with respect to the surface of the first peripheral mold member 1a on the side of the cavity 7, as depicted in FIG. 5. This configuration enables the first surface of the plate-like optical component to be formed in a smooth concave shape with respect to the end portion of the plate-like optical component, while maintaining the same thickness of the end portion of the plate-like optical component. This facilitates giving an optical function to the first surface of the plate-like optical component.

The surface of the second peripheral mold member 2a on the side of the cavity 7 protrudes toward the cavity 7 with respect to the surface of the second surface mold member 2b on the side of the cavity 7, as depicted in FIG. 5. This makes it possible to form the second peripheral portion having a thickness greater than the second surface, and thus obtain the plate-like optical component whose end portion (second peripheral portion 6b) has high rigidity.

As depicted in FIG. 8, in a plan view of the stationary mold half 1 as viewed from the side of the cavity 7, the first surface mold member 1b has an approximately rectangular shape. As depicted in FIG. 8, in the plan view of the stationary mold half 1 as viewed from the side of the cavity 7, as depicted in FIG. 8, a ratio (W/L) of a width dimension W of the first peripheral mold member 1a to a maximum length dimension L of the stationary mold half 1 in the rightward-leftward direction thereof is preferably 0.04 or less, more preferably 0.03 or less, even more preferably 0.02 or less, particularly preferably 0.01 or less. By using the stationary mold half 1 having such a shape, it becomes possible to reduce the width of the first peripheral portion of the plate-like optical component and thus make it less likely that the first peripheral portion is recognized from outside.

In the plan view of the stationary mold half 1 as viewed from the side of the cavity, the width dimension W of the first peripheral mold member 1a on the side of the cavity is preferably 0.2 mm or more, more preferably 0.3 mm or more, even more preferably 0.5 mm or more. By forming the first peripheral mold member 1a to have such a shape, it becomes possible to increase the rigidity of the end portion (first peripheral portion) of the plate-like optical component. This can make it less likely that chip or deformation occurs in the end portion of the plate-like optical component.

(Production Method for Plate-Like Optical Component)

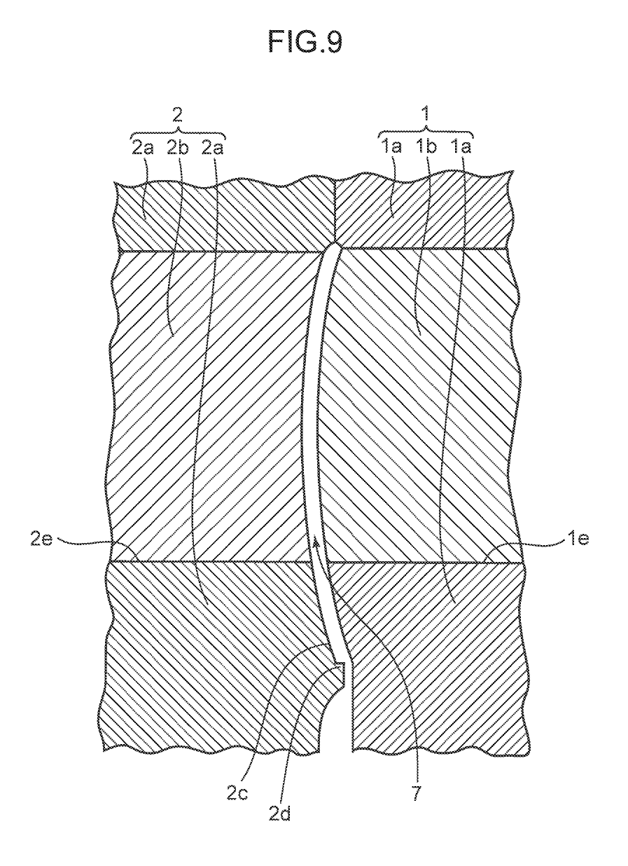

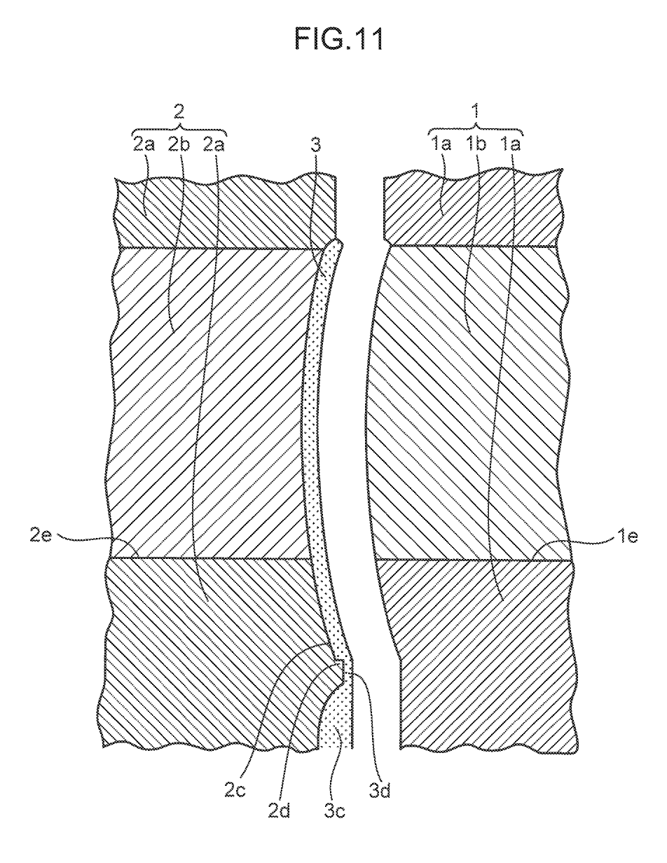

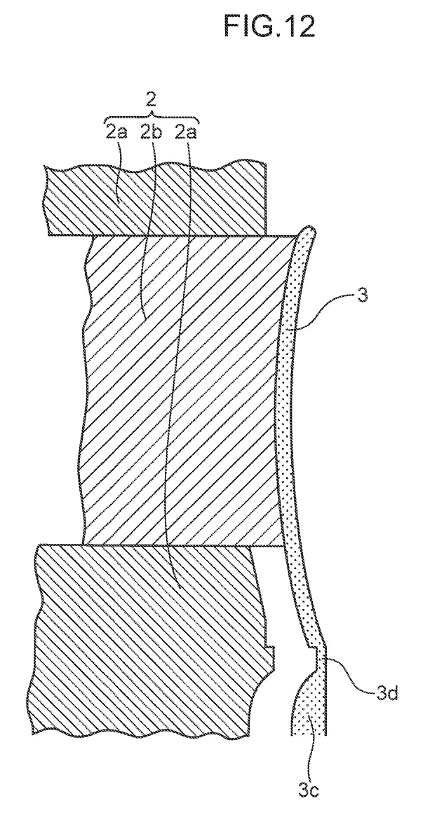

A plate-like optical component production method using the above mold will be described. FIG. 9 is a schematic sectional view depicting a state after clamping the stationary mold half and the movable mold half together. FIG. 10 is a schematic sectional view depicting a state after producing the plate-like optical component in a cavity. FIG. 11 is a schematic sectional view depicting a state after separating the plate-like optical component from the stationary mold half by moving the movable mold half. FIG. 12 is a schematic sectional view depicting a state after separating the plate-like optical component from a second peripheral mold member.

In a production method for the plate-like optical component 3 according to this embodiment, first of all, as depicted in FIG. 9, the stationary mold half 1 and the movable mold half 2 are clamped together to form the cavity 7 between the stationary mold half 1 and the movable mold half 2. Then, as depicted in FIG. 10, molten resin is filled in the cavity 7 and cured to form the plate-like optical component 3. Subsequently, as depicted in FIG. 11, the movable mold half 2 is moved to thereby separate the movable mold half 2 from the stationary mold half 1 together with the plate-like optical component 3. Then, a solid resin integrally including the plate-like optical component 3 is detached from the movable mold half 2. Last of all, the solid resin is cut at the gate cut portion to obtain the plate-like optical component 3. In this process, when the plate-like optical component 3 is detached from the movable mold half 2, this detachment is preferably achieved by causing the second surface mold member 2b of the movable mold half 2 to relatively protrude with respect to the second peripheral mold member 2a of the movable mold half 2.

By producing the plate-like optical component 3 using the above production method, the plate-like optical component 3 can be easily separated and detached, respectively, from the stationary mold half 1 and the movable mold half 2, so that it becomes possible to obtain the plate-like optical component 3 with good external appearance. In addition, the plate-like optical component 3 produced by this method is capable of suppressing light reflection at the end portion thereof and suppressing injury of a user due to the end portion of the plate-like optical component 3.

### Modification of Embodiment 1

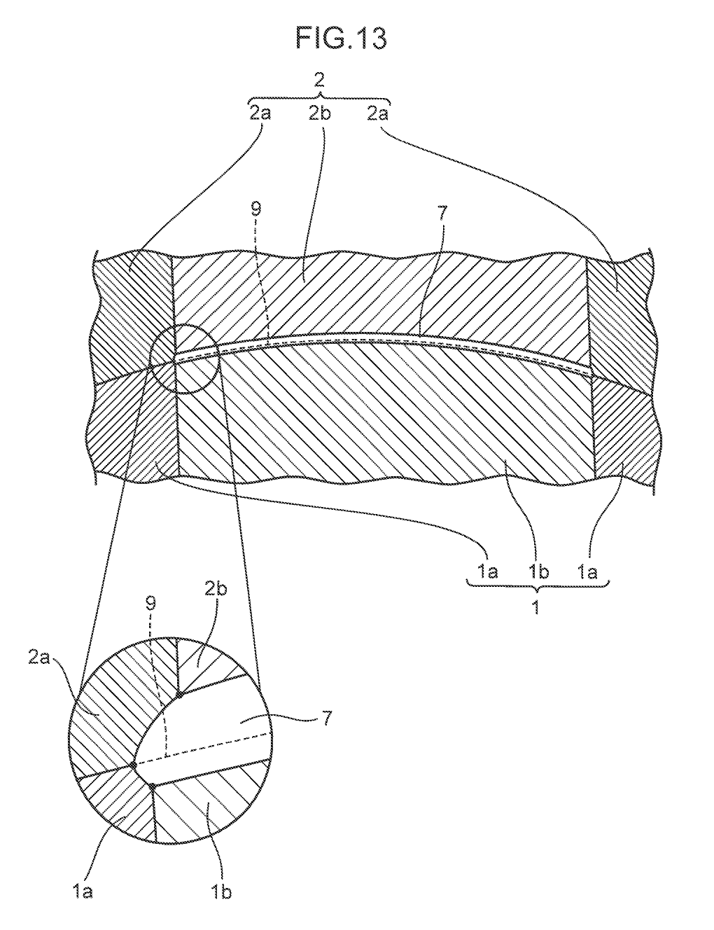

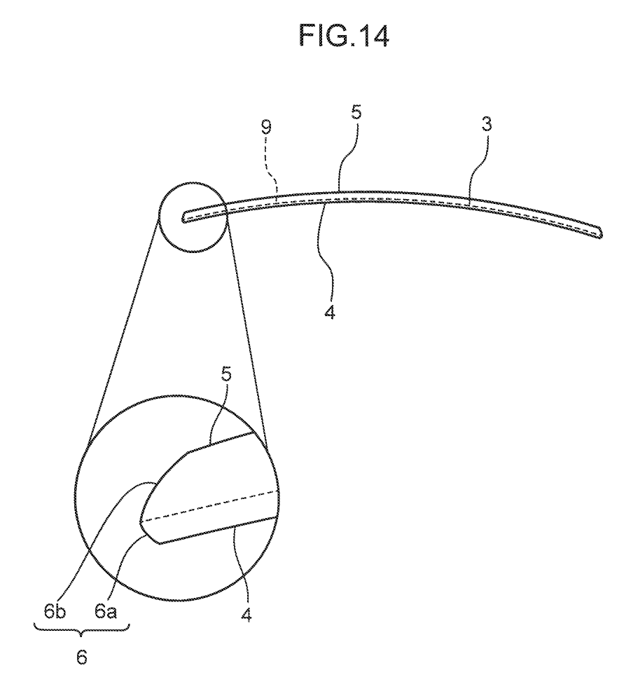

FIG. 13 is a sectional view of a mold in a modified embodiment 1, taken along the plane perpendicular to the upward-downward direction. FIG. 14 is a top view of a plate-like optical article according to a modified embodiment 1, as viewed from thereabove. In the embodiment 1, as depicted in FIG. 5, the surface of the first surface mold member 1b of the stationary mold half 1 on the side of the cavity protrudes toward the cavity with respect to the surface of the first peripheral mold member 1a on the side of the cavity. In addition, the surface of the second surface mold member 2b on the side of the cavity protrudes toward the cavity 7 with respect to the surface of the second peripheral mold member 2a on the side of the cavity. Alternatively, as depicted in FIG. 13 for example, the first surface mold member 1b and the first peripheral mold member 1a of the stationary mold half 1 may be arranged such that respective adjacent ridge lines thereof are coincident with each other, and the second surface mold member 2b and the second peripheral mold member 2a of the movable mold half 2 may be arranged such that respective adjacent ridge lines thereof are coincident with each other. By producing the plate-like optical component 3 using the mold having such a shape, the plate-like optical component 3 can be produced such that the first peripheral portion 6a and the first surface 4 are smoothly connected to each other, and the second peripheral portion 6b and the second surface 5 are smoothly connected to each other, as depicted in FIG. 14. By providing the first peripheral portion 6a having such a shape, it becomes possible to improve quality of external appearance in the end portion (first and second peripheral portions 6a, 6b) of the plate-like optical component 3.

### Outline of Embodiment

According to an aspect, there is provided a mold for forming therein a cavity for producing a plate-like optical component. The mold includes: a stationary mold half; and a movable mold half which is clamped with respect to the stationary mold half through respective parting surfaces thereof to thereby form the cavity in cooperation with the stationary mold half, wherein the stationary mold half includes: a first surface mold member for forming a first surface which is one of obverse and reverse surfaces of the plate-like optical component; and a first peripheral mold member for connecting a cavity-side surface of the movable mold half and a cavity-side surface of the first surface mold member, wherein the first peripheral mold member inclines or curves to cause a dimension of the cavity in a direction of a plane approximately parallel to the first surface to become gradually smaller as being closer to the first surface.

According to the above configuration, when the plate-like optical component is extracted from the mold, a surface of the plate-like optical component connecting between the parting surface and the first surface thereof inclines or curves. The above configuration makes it possible to obtain a plate-like optical component whose end portion has a smooth shape, without subjecting the end portion of the plate-like optical component to processing. The end portion having a smooth shape makes it possible to suppress light reflection at the end portion and suppress injury of a user due to the end portion of the plate-like optical component.

In the above configuration, the movable mold half includes: a second surface mold member for forming a second surface lying in spaced-apart relation to the first surface; and a second peripheral mold member for connecting a surface of the stationary mold half on a side of the cavity and a surface of the second surface mold member on a side of the cavity, wherein the second peripheral mold member inclines or curves to cause a dimension of the cavity in a direction of a plane approximately parallel to the second surface to become gradually smaller as being closer to the second surface.

According to the above configuration, when the plate-like optical component is extracted from the mold, a surface of the plate-like optical component connecting between the parting surface and the second surface thereof inclines or curves. The above configuration makes it possible to facilitate release of the plate-like optical component from the movable mold half, and obtain the plate-like optical component with good quality of external appearance.

In a plan view of the stationary mold half as viewed from a side of the cavity, a ratio (W/L) of a width dimension W of the first peripheral mold member to a maximum length dimension L of the stationary mold half in a rightward-leftward direction thereof is 0.04 or less. In a plate-like optical component produced using the stationary mold half having the above shape, the first peripheral portion formed by the first peripheral mold member has a relatively small width, so that it becomes possible to form the first peripheral portion such that it is less likely to be recognized from outside, and to obtain the plate-like optical component with excellent external appearance.

In the above configuration, the parting surfaces are located on a side of the first surface mold member with respect to an intermediate position between the surface of the first surface mold member on a side of the cavity and the surface of the second surface mold member on a side of the cavity. According to this configuration, it becomes possible to facilitate release of a plate-like optical component from the stationary mold half, and easily produce a plate-like optical component with good external appearance.

In the above configuration, the surface of the first surface mold member on a side of the cavity protrudes toward the cavity with respect to a surface of the first peripheral mold member on a side of the cavity. According to this configuration, the first peripheral portion formed by the first peripheral mold member protrudes with respect to the first surface formed by the first surface mold member, so that a thickness of the first peripheral portion of the plate-like optical component is partially increased. This makes it possible to increase the rigidity of the end portion (first peripheral portion) of the plate-like optical component.

In the above configuration, a width dimension W of the first peripheral mold member on a side of the cavity, in a plan view of the stationary mold half as viewed from the side of the cavity, is 0.2 mm or more.

According to this configuration, the width of the first peripheral portion to be formed by the first peripheral mold member can be sufficiently ensured, so that it becomes possible to increase the rigidity of the end portion (first peripheral portion) of the plate-like optical component, thereby providing an advantage that chip or deformation is less likely to occur in the end portion of the plate-like optical component.

According to an aspect, there is provided a plate-like optical component produced by filling molten resin in a cavity formed by clamping a stationary mold half and a movable mold half together, and curing the molten resin. The plate-like optical component has: a first surface which is one of obverse and reverse surfaces of the plate-like optical component; a second surface which lies in spaced-apart relation to the first surface; a lateral face which connects the first surface and the second surface together; and a parting line which is formed on the lateral face by respective contact surfaces of the stationary mold half and the movable mold half, wherein a part of the lateral face which connects between the parting line and an outer periphery of the first surface is a first peripheral portion inclining or curving to cause a dimension of the plate-like optical component in a direction of a plane approximately parallel to the first surface to become gradually smaller as being closer to the first surface. In addition, a remaining part of the lateral face which connects between the parting line and an outer periphery of the second surface is a second peripheral portion inclining or curving to cause a dimension of the plate-like optical component in a direction of a plane approximately parallel to the second surface to become gradually smaller as being closer to the second surface.

The first peripheral portion and the second peripheral portion of the plate-like optical component incline or curve in the above manner, so that the end portion of the plate-like optical component has a smooth surface. This makes it possible to suppress light reflection at the end portion and suppress injury of a user due to the end portion of the plate-like optical component.

In the above configuration, in a plan view as viewed from the side of the first surface, a ratio (W/L) of a width dimension W of the first peripheral portion to a maximum length dimension L of the plate-like optical component in a rightward-leftward direction thereof is 0.04 or less.

By using the above plate-like optical component, the first peripheral portion becomes less likely to be recognized from outside, thereby providing excellent external appearance of the plate-like optical component.

In the above configuration, the parting line is located on the lateral face at a position on the side of the first surface with respect to an intermediate position between the first surface and the second surface. According to this configuration, it becomes possible to facilitate release of the plate-like optical component from the stationary mold half and thus obtain the plate-like optical component with good external appearance.

In the above configuration, the first peripheral portion protrudes with respect to the first surface. Preferably, a width dimension of the first peripheral portion in a plan view as viewed from the side of the first surface is 0.2 mm or more.

According to the above configuration, the thickness of the first peripheral portion of the plate-like optical component can be increased, and the rigidity of the end portion (first peripheral portion) of the plate-like optical component can be increased, which provides an advantage that chip or deformation is less likely to occur in the plate-like optical component.

According to an aspect, there is provided a plate-like optical component production method which includes the steps of: clamping a stationary mold half and a movable mold half together to form a cavity between the stationary mold half and the movable mold half; filling molten resin in the cavity and curing the molten resin to form a plate-like optical component; separating the movable mold half from the stationary mold half together with the plate-like optical component; and detaching the plate-like optical component from the movable mold half, wherein the movable mold half includes: a second surface mold member for forming a second surface of the plate-like optical component; and a second peripheral mold member for connecting a surface of the stationary mold half on a side of the cavity and a surface of the second surface mold member on a side of the cavity, wherein the second peripheral mold member inclines or curves to cause a dimension of the cavity in a direction of a plane approximately parallel to the first surface to become gradually smaller as being closer to the second surface, and wherein the step of detaching the plate-like optical component includes a step of causing the second surface mold member of the movable mold half to relatively protrude with respect to the second peripheral mold member of the movable mold half.

Producing the plate-like optical component by the above production method makes it possible to easily detach the plate-like optical component from the stationary mold half and the movable mold half, so that it becomes possible to obtain a plate-like optical component with good external appearance. In addition, the plate-like optical component produced in this way is capable of suppressing light reflection at the end portion thereof and suppressing injury of a user due to the end portion of the plate-like optical component.

### EXAMPLES

### Example 1

A stationary mold half 1 having a rightward-leftward directional maximum length L of 50 mm and an upward-downward directional length of 25 mm, and a corresponding movable mold half 2 were clamped through respective parting surfaces thereof to form a cavity 7 between the stationary mold half 1 and the movable mold half 2, as depicted in FIG. 9. Liquid resin was injected into the cavity 7, and made to room temperature to form a plate-like optical component 3 in the cavity 7, as depicted in FIG. 10. The stationary mold half 1 used includes a first peripheral mold member 1a capable of forming a first peripheral portion having a width of 0.1 mm.

Subsequently, the movable mold half 2 was moved with respect to the stationary mold half 1 to separate the plate-like optical component 3 from the stationary mold half 1, as depicted in FIG. 11. Lastly, a second surface mold member 2b of the movable mold half 2 was moved to protrude with respect to a second peripheral mold member 2a to separate the plate-like optical component 3 from the second peripheral mold member 2a, as depicted in FIG. 12. The plate-like optical component 3 obtained in this manner could be easily separated and detached from the stationary mold half 1 and the movable mold half 2, thereby achieving good external appearance. In the obtained plate-like optical component 3, a rightward-leftward directional maximum length L thereof was 50 mm, and a width dimension W of the first peripheral portion thereof was 0.1 mm.

### Examples 2 to 7

Except that a shape of the mold was changed with respect to Example 1 to enable the width dimension W of the first peripheral portion to become 0.2 mm, 0.5 mm, 1 mm, 2 mm, 5 mm and 10 mm, respective plate-like optical components in Examples 2 to 7 were produced in the same manner as that in Example 1.

(Production Evaluation)

As a result of producing plate-like optical components using the molds in Examples 1 to 7, it was verified that a plate-like optical component whose end portion has a smooth shape can be produced in a simple manner, i.e., the advantageous effect of the present invention was demonstrated. Each of the plate-like optical components produced in the above manner had a smooth end portion. Thus, it is considered that light reflection due to the end portion is less likely to occur, and a risk of injury of a user due to the end portion is also small.

(Visual Evaluation)

Each of the plate-like optical components produced in Examples 1 to 7 was observed from a position opposed to the first surface thereof and spaced apart therefrom by 50 cm to evaluate whether or not the presence of the first peripheral portion can be visually identified. A result of the evaluation is presented in the field “Visual Evaluation” in the following Table 1. In the visual evaluation, as the presence of the first peripheral portion becomes harder to be recognized, external appearance of the plate-like optical component is evaluated to be better.

(Rigidity Evaluation)

A finger pressure was applied to the first peripheral portion of each of the plate-like optical components produced in Examples 1 to 7, and a change in shape of the first peripheral portion after the finger pressure was microscopically observed. A result of the observation is presented in the field “Rigidity Evaluation” in the following Table 1. In the rigidity evaluation, as deformation of the first peripheral portion observed is smaller, the rigidity of the plate-like optical component is evaluated to be better.

TABLE 1

| | Width of First | | | |
|---|---|---|---|---|
| | Peripheral Portion | | | Rigidity |
| | W (mm) | W/L | Visual Evaluation | Evaluation |
| Example 1 | 0.1 | 0.002 | Unrecognizable | Almost no |
| | | | | change |
| Example 2 | 0.2 | 0.004 | Unrecognizable | No change |
| Example 3 | 0.5 | 0.01 | Unrecognizable | No change |
| Example 4 | 1 | 0.02 | Almost | No change |
| | | | unrecognizable | |
| Example 5 | 2 | 0.04 | Almost | No change |
| | | | unrecognizable | |
| Example 6 | 5 | 0.1 | Slightly recognizable | No change |
| Example 7 | 10 | 0.2 | Slightly recognizable | No change |

From the result of “Visual Evaluation” in Table 1, it was proven that, when the ratio (W/L) of the width dimension W of the first peripheral portion to the rightward-leftward directional maximum length dimension L of the plate-like optical component is 0.04 or less, it is possible to enable the first peripheral portion to become almost unable to be visually recognized, thereby providing good external appearance of the plate-like optical component. Further, from the result of “Rigidity Evaluation” in Table 1, it was proven that, when the width dimension W of the first peripheral portion is 0.2 mm or more, deformation of the first peripheral portion is less likely to occur even after pressing the first peripheral portion.

This application is based on Japanese Patent Application Serial No. 2015-143920 filed in Japan Patent Office on Jul. 21, 2015, the contents of which are incorporated herein by reference.

While the present invention has been described appropriately and fully by way of the embodiment as above with reference to the drawings in order to express the present invention, it should be appreciated that anyone skilled in the art can readily change and/or modify the embodiment described above. It is therefore understood that a changed embodiment or a modified embodiment implemented by anyone skilled in the art is enclosed within the scope of the appended claims unless the changed embodiment or the modified embodiment is of a level that deviates from the scope of the appended claims.

### INDUSTRIAL APPLICABILITY

The present invention provides a mold capable of simply producing a plate-like optical component having an end portion with a smooth shape, a plate-like optical component produced using the mold, and a production method for the plate-like optical component.

1. A mold for forming therein a cavity for producing a plate-like optical component, comprising:
a stationary mold half; and
a movable mold half clamped with respect to the stationary mold half through respective parting surfaces thereof to form the cavity in cooperation with the stationary mold half, wherein
the stationary mold half includes:
a first surface mold member that forms a first surface that is one of obverse and reverse surfaces of the plate-like optical component; and
a first peripheral mold member that connects a surface of the movable mold half on a side of the cavity and a surface of the first surface mold member on a side of the cavity, wherein
the first peripheral mold member is inclined or curved to cause a dimension of the cavity in a direction of a plane approximately parallel to the first surface to become gradually smaller as being closer to the first surface.

2. The mold according to claim 1, wherein
the movable mold half includes:
a second surface mold member that forms a second surface lying in spaced-apart relation to the first surface; and
a second peripheral mold member that connects a surface of the stationary mold half on a side of the cavity and a surface of the second surface mold member on a side of the cavity, wherein
the second peripheral mold member is inclined or curved to cause a dimension of the cavity in a direction of a plane approximately parallel to the second surface to become gradually smaller as being closer to the second surface.

3. The mold according to claim 1, wherein
a ratio (W/L) of a width dimension W of the first peripheral mold member to a maximum length dimension L of the stationary mold half in a rightward-leftward direction thereof is 0.04 or less, in a plan view of the stationary mold half as viewed from a side of the cavity.

4. The mold according to claim 2, wherein
the parting surfaces are located on a side of the first surface mold member with respect to an intermediate position between the surface of the first surface mold member on a side of the cavity and the surface of the second surface mold member on a side of the cavity.

5. The mold according to claim 1, wherein
the surface of the first surface mold member on a side of the cavity protrudes toward the cavity with respect to a surface of the first peripheral mold member on a side of the cavity.

6. The mold according to claim 1, wherein
a width dimension W of the first peripheral mold member on a side of the cavity, in a plan view of the stationary mold half as viewed from the side of the cavity, is 0.2 mm or more.

7. A plate-like optical component produced by filling molten resin in a cavity formed by clamping a stationary mold half and a movable mold half together, and curing the molten resin, the plate-like optical component comprising:
a first surface that is one of obverse and reverse surfaces of the plate-like optical component;
a second surface that lies in spaced-apart and is opposed relation to the first surface;
a lateral face that connects the first surface and the second surface together; and
a parting line that is formed on the lateral face by respective contact surfaces of the stationary mold half and the movable mold half, wherein
a part of the lateral face that connects between the parting line and an outer periphery of the first surface is a first peripheral portion that is inclined or curved to cause a dimension of the plate-like optical component in a direction of a plane approximately parallel to the first surface to become gradually smaller as being closer to the first surface.

8. The plate-like optical component according to claim 7, wherein
a remaining part of the lateral face that connects between the parting line and an outer periphery of the second surface is a second peripheral portion that is inclined or curved to cause a dimension of the plate-like optical component in a direction of a plane approximately parallel to the second surface to become gradually smaller as being closer to the second surface.

9. The plate-like optical component according to claim 7, wherein
a ratio (W/L) of a width dimension W of the first peripheral portion to a maximum length dimension L of the plate-like optical component in a rightward-leftward direction thereof is 0.04 or less, in a plan view as viewed from the side of the first surface.

10. The plate-like optical component according to claim 7, wherein
the parting line is located on the lateral face at a position on the side of the first surface with respect to an intermediate position between the first surface and the second surface.

11. The plate-like optical component according to claim 7, wherein
the first peripheral portion protrudes with respect to the first surface.

12. The plate-like optical component according to claim 7, wherein
a width dimension of the first peripheral portion in a plan view as viewed from the side of the first surface is 0.2 mm or more.

13. A plate-like optical component production method comprising:
clamping a stationary mold half and a movable mold half together to form a cavity between the stationary mold half and the movable mold half;
filling molten resin in the cavity and curing the molten resin to form a plate-like optical component;
separating the movable mold half from the stationary mold half together with the plate-like optical component; and
detaching the plate-like optical component from the movable mold half,
wherein the movable mold half includes:
a second surface mold member that forms a second surface of the plate-like optical component; and
a second peripheral mold member that connects a surface of the stationary mold half on a side of the cavity and a surface of the second surface mold member on a side of the cavity, wherein
the second peripheral mold member is inclined or curved to cause a dimension of the cavity in a direction of a plane approximately parallel to the second surface to become gradually smaller as being closer to the second surface, and
wherein the detaching of the plate-like optical component includes causing the second surface mold member of the movable mold half to relatively protrude with respect to the second peripheral mold member of the movable mold half.
